(19) United States
(12) Patent Application Publication
(10) Pub. No.: US 2010/0215094 A1
(43) Pub. Date: Aug. 26, 2010

(54) VIDEO DECODING

(75) Inventor: Kai Wang, Beijing (CN)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/680,581

(22) PCT Filed: Oct. 3, 2008
(86) PCT No.: PCT/IB08/54059

§ 371 Date: Mar. 29, 2010

(30) Foreign Application Priority Data
Oct. 8, 2007 (EP) 07118066.5

(51) Int. Cl. H04N 7/26; H04N 7/30

(52) U.S. Cl. 375/240.2; 375/E07.226; 375/E07.227

(57) ABSTRACT

A method of decoding a digital video file comprising a plurality of encoded frames each having a first number of pixels, each encoded frame composed of an integer multiple of n-order square matrices, the method comprising: i) for each n-order square matrix, performing an inverse discrete cosine transformation on the n-order square matrix to produce an m-order square matrix, where m<n; ii) for each m-order square matrix, reducing the m-order square matrix to a p×m matrix, where p<m; iii) for each frame, producing a decoded frame composed of the integer multiple of p×m matrices derived from step ii), wherein each decoded frame has a second number of pixels smaller than the first number of pixels.

The invention relates to decoding of digital video data, and in particular to methods of decoding digital video data to enable high resolution video to be played on lower resolution screens.

In order to view video on a portable device, it is necessary that the device supports a video standard. A preferred standard for digital video is known generally as “MPEG-4”, being a fourth generation standard devised by the ISO (International Standards Organisation) Moving Pictures Experts Group. MPEG-4 videos can be displayed at many different resolutions and frame rates to suit a wide range of applications.

A common type of encoded video file suitable for portable media and wired or wireless internet transmission is a cif mpeg-4 file. Cif (Common Intermediate Format) video has a resolution of 352×288 pixels. This resolution, while adequate for playback on many devices such a computer monitors, may be too large for screens on, for example, hand-portable radio telephones (commonly known as mobile phones or cellphones). A reduced resolution format is therefore preferable, such as mpeg-4 qcif (Quarter Common Intermediate Format). Qcif mpeg-4 video, as the name suggests, has a quarter the resolution of cif mpeg-4, i.e. 176×144 pixels.

Throughout the specification, the term ‘pixel resolution’ is intended to relate to the number of pixels in a particular frame or image, for example as expressed in terms of the number of horizontal and vertical pixels defining a frame.

Compared with the requirements for qcif, cif requires considerably higher CPU power levels, a change to the cache memory to provide sufficient space, and an increase in memory requirements. An attempt by a user to play a cif format mpeg-4 file on a video-enabled mobile phone may therefore result in an error message.

Support for mpeg-4 on a mobile phone is preferable, but the type of file a typical mobile phone will be able to play may be limited by its processing power. For example, a mobile phone with one ARMS processor operating at 100 MIPS (100×10⁶ instructions per second) may be able to process a qcif mpeg-4 file at 15 frames per second. In order to play higher resolution cif mpeg-4 files with only a qcif size screen, such an arrangement is inefficient for reasons of CPU power and memory capacity. When faced with a cif mpeg-4 file therefore, such a mobile phone may consequently be unable to play the video, and be forced to return an error message to the user instead.

A problem therefore arises of how to play a large (or high resolution) mpeg-4 file on a mobile phone having a smaller resolution screen and with only sufficient computing power to decode a smaller resolution mpeg-4 file.

It is an object of the invention to address one or more of the above problems.

The invention provides a method of decoding a digital video file comprising a plurality of encoded frames each having a first number of pixels, each encoded frame composed of an integer multiple of n-order square matrices, the method comprising:

i) for each n-order square matrix, performing an inverse discrete cosine transformation on the n-order square matrix to produce an m-order square matrix, where m<n;

ii) for each m-order square matrix, reducing the m-order square matrix to a p×m matrix, where p<m;

iii) for each frame, producing a decoded frame composed of a plurality of p×m matrices derived from step ii),

wherein each decoded frame has a second number of pixels smaller than the first number of pixels.

The invention is implemented in computer hardware, and can therefore be embodied in the form of a computer program product comprising a computer readable medium having thereon computer program code means adapted, when said program is loaded onto a computer, to make the computer execute the method of the invention.

The invention is preferably implemented on a portable electronic device, being for example a mobile phone.

The invention will now be described in detail by way of example only, with reference to the appended drawings, in which:

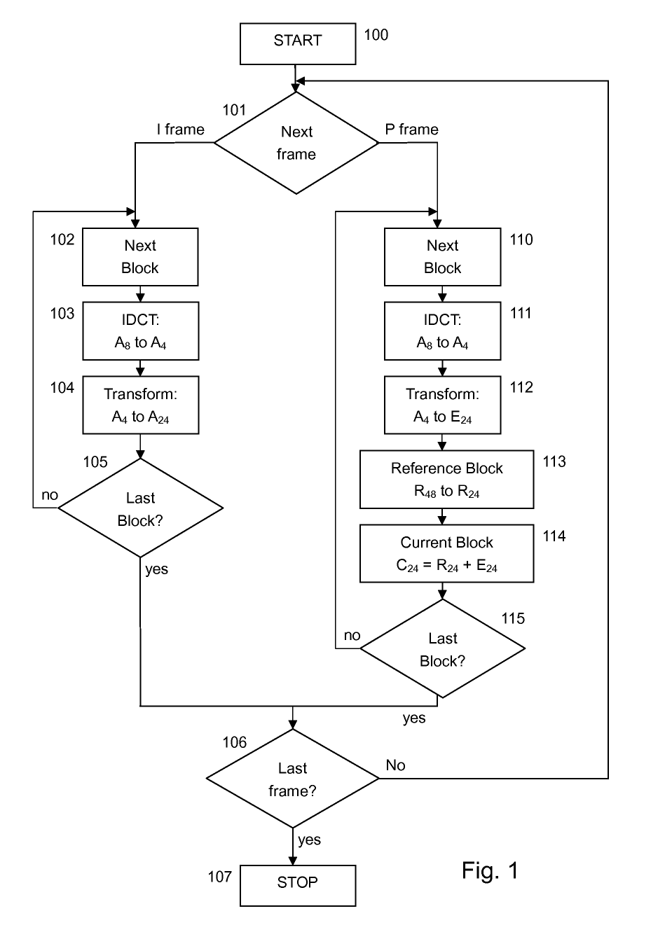

FIG. 1 illustrates an exemplary sequence of steps for decoding a video file comprising I-frames and P-frames; and

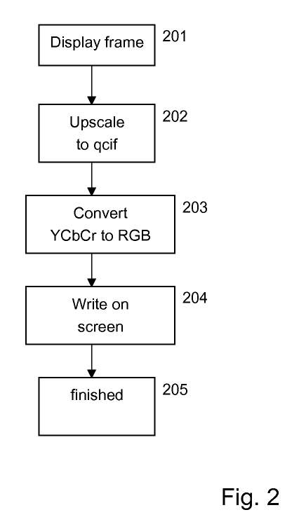

FIG. 2 illustrates an exemplary sequence of steps for displaying a decoded frame derived from the decoding process of FIG. 1.

The following should not be construed as limiting the invention, which is to be defined by the appended claims.

For simplicity, the following exemplary embodiment relates to decoding of a cif mpeg-4 file on a mobile phone having a qcif resolution screen (176×144 pixels) and having sufficient computing power only to decode a qcif mpeg-4 file.

In a typical SP (Simple Profile) cif mpeg-4 file, there are two kinds of frames: I (Intra) frames and P (Predicted) frames.

For each I frame, after dequantising, a 4×4 IDCT (Inverse Discrete Cosine Transform) operation is carried out on the 8×8 DCT (Discrete Cosine Transform) matrices making up the I frame. The IDCT operation is performed according to the following equation:

A₄=(D₄′*(I₄,O₄)*A₈*(I₄,O₄)′*D₄)·/2

where A₄ is the 4×4 output matrix, A₈ is the (dequantised) 8×8 matrix in the DCT field, I₄ is a 4×4 unity matrix, O₄ is a 4×4 zero matrix, and D₄ is a standard 4×4 DCT matrix. D₄′ is the transpose of D₄, and (I₄,O₄)′ is the transpose of (I₄,O₄). X./2 means that all elements in the matrix X are divided by 2. The effect of this operation is to perform an inverse discrete cosine transform on the top left 4×4 portion of the 8×8 A₈ matrix, resulting in the 4×4 output matrix A₄.

The 4×4 matrix A₄ is then transformed into a 2×4 matrix A₂₄:

A₂₄=T*A₄

The matrix T comprises elements that are chosen such that rows of the A₄ matrix are averaged in the matrix calculation to produce the A₂₄ matrix. For example, the matrix T can be of the form:

$$[ \begin{matrix}0.5 & 0.5 & 0 & 0 \\ 0 & 0 & 0.5 & 0.5\end{matrix} ] .$$

The above operation thereby effectively averages vertically adjacent pixels in the upper and lower two rows of the matrix A₄, to produce the smaller matrix A₂₄.

As a result, the decoded frame has a pixel resolution of 176×72. The decoded frame is preferably in YCbCr (or YUV) format, which can then be processed further to RGB format, and optionally upscaled to the qcif resolution of 176×144 pixels, for display on a suitable screen.

For each P frame, the same method described above may be used to produce 2×4 error matrices, E₂₄. For these prediction matrix calculations, the method described by Vetro and Sun, in “On the Motion Compensation Within a Down-Conversion Decoder”, SPIE Journal of Electronic Imaging, July 1998, may be used. In summary, this method comprises:

i) finding a 4×8 macro block including a 2×4 reference block, the reference block being named R₄₈; and

ii) computing the reference block R₂₄:

R₂₄=P₂₄*R₄₈*P₈₄

In the above formula, P₂₄ is a 2×4 matrix, P₂₄=(N₁,N₂), N₁, N₂ are 2×2 matrices, N₁=D₂*S₁*D₂′, N₂=D₂*S₂*D₂′, D₂ is a 2×2 DCT transform matrix, and S₁, S₂ are 2×2 matrices based on the MV (mean motion vector). The matrix P₈₄ is a 8×4 matrix, where P₈₄=(M₁,M₂)′, M₁ and M₂ being 4×4 matrices, where M₁=D₄*P₁*D₄′, M₂=D₄*P₂*D₄′, and P₁, P₂ are 4×4 matrices based on the MV.

The matrices S₁ and S₂ are derived based on the vertical MV. For example, for MV_y/4=0, S₁=[1,0;0,1], S₂=[0,0;0,0]. If MV_y/4=1, then S₁=[0, 1;0,0], S₂=[0,0;1,0]. P₁ and P₂ are derived from the horizontal MV. Normally, for an inter block in a P frame, there is one reference block in its reference frame. When decoding, the reference block can be found by the MV. The error block is then decoded and added to the reference block. In this case, an 8*8 block becomes a 2×4 block, so the reference block should be 2×4 too. It must be in one 4×8 macro block, so R₄₈ is the macro block containing that 2×4 reference block.

The current block O₂₄ is then calculated by the following:

C₂₄=R₂₄+E₂₄

A decoded YCbCr frame of resolution 176×72 resulting from the above processes can then be turned into an RGB frame and optionally upscaled to the qcif resolution of 176×144 pixels. Reducing the resolution to 176×72 followed by upscaling has the effect of reducing CPU and memory load.

The above decoding method is represented in the flow chart shown in FIG. 1, which illustrates an exemplary sequence of steps for decoding a video file comprising I-frames and P-frames. The sequence begins at step 100, proceeding to step 101 for the first (or next) frame, which may be either an I-frame or a P-frame. If the frame is an I-frame, each block in the I-frame is transformed (steps 102 to 104), the procedure repeating via step 105 until the last block in the current I-frame is reached. The process then proceeds to the next frame (step 101). If the next frame is a P-frame, each block in the P-frame is analysed and transformed (steps 110 to 114), including the same procedure (steps 110 to 112) as for each block in an I-frame, but followed by calculation of the current block C₂₄ based on the reference block from the P-frame (steps 113 and 114). The sequence of steps 110-115 is repeated until the last block in the P-frame is reached (step 115). The procedure for each P-frame and each I-frame is repeated, via steps 106 and 101 until the last frame is reached. The procedure then stops (step 107).

FIG. 2 illustrates an exemplary sequence of steps for displaying a decoded frame derived from the decoding process. The frame chosen to be displayed (step 201) is upscaled to qcif size (step 202), converted from YCbCr to RGB format (step 203), and written on the screen (step 204). The process then stops (step 205), or repeats for the next frame to be displayed.

Using the above methods, cif mpeg-4 video files can be transformed into a series of qcif images on a device (such as a mobile phone) which has just sufficient power to decode qcif mpeg-4 files, but may not have sufficient power to decode and display cif mpeg-4 files.

The CPU and memory resources needed by the above decoding method and a conventional mpeg4 decoder are compared in the table below. In this table, the CPU requirements are given in terms of the number of multiplications required, and the memory requirements are given in terms of the number of bytes required for decoding each frame.

| | Conventional mpeg-4 | New mpeg4 decoder for |
|---|---|---|
| | qcif decoder | cif files |
| CPU | Each 8 × 8 IDCT needs 192 | Each 4 × 4 IDCT needs 32 |
| requirements | multiplications; | multiplications; |
| | Each qcif frame needs | Each cif frame needs: |
| | 192 * 22 * 18 * 1.5 = | 32 * 32 * 44 * 36 * 1.5 = |
| | 114048 multiplications. | 76032 multiplications; To |
| | | compute a reference 2 × 4 |
| | | matrix requires 128 |
| | | multiplications; |
| | | To compute a cif frame |
| | | requires |
| | | 128 * 44 * 36 * 1.5 = |
| | | 304128 multiplications; |
| | | Total = 380160 |
| | | multiplications. |
| Memory | 176 * 144 * 1.5 bytes for | 176 * 72 * 1.5 bytes for |
| requirements | reference frame; | reference frame; |
| | 176 * 144 * 1.5 bytes for | 176 * 72 * 1.5 bytes for |
| | current frame | current frame |

Although the above multiplication method requires over 3 times the number of multiplications as a normal decoder, because the CPU occupancy of the DCT module is about 10%-15% of the whole mpeg-4 decoding process, the incremental CPU load is comparatively small. Normally for a decoder, most CPU power is used by motion compensation. IDCT only occupies about 10-15% of the CPU compared with the total decoder CPU occupancy. Increasing the number of multiplications in the IDCT process will increase the total decoding CPU occupancy by only around 20%-30%. Because the final frame size decreases, the quantity of data required to be read and written decreases, and cache use consequently decreases. Decreasing size of the frame means decreasing the read time of memory, causing cache misses to decrease accordingly. This can make decoding faster. The decoding speed of the above method, as applied to decoding cif mpeg-4 files in qcif format, is estimated to be about equal to the speed of conventional qcif mpeg-4 decoding process.

The following provides a method of detecting whether decoding according to the above method is being carried out in a device, through providing the device with data comprising test matrices.

The above method transforms an 8×8 matrix into a 2×4 matrix, i.e.:

A₂₄=T*A₄=T*D₄′*(I₄,O₄)*A₈*(I₄,O₄)′*D₄

where the matrices are defined as above.

If we make A₈ a special matrix:

$$[ \begin{matrix}{D}_{4}^{′} * S * {D}_{4} & {M}_{1} \\ {M}_{2} & {M}_{3}\end{matrix} ]$$

where D₄ is the 4×4 DCT transform matrix, M₁, M₂, M₃ are any 4×4 matrices and S is the matrix:

$$[ \begin{matrix}- a & - a & - a & - a \\ a & a & a & a \\ - a & - a & - a & - a \\ a & a & a & a\end{matrix} ]$$

where a≠0 (a is not equal to zero). Then, if the matrix above is processed according to the above method, the resulting A₂₄ matrix will be a zero matrix.

As an exemplary test method for detecting whether decoding according to the above method is being carried out, if an I frame is composed of copies of the above A₈ matrix, the decoded frame will be displayed as a black frame, since all decoded data will be 0. If, however, this I frame is processed in a conventional decoder, the decoded frame will not be a black frame. A decoder employing the methods according to certain aspects of the invention can thereby be detected.

Other embodiments are intentionally within the scope of the invention as defined by the appended claims.

1. A method of decoding a digital video file having a plurality of encoded frames each having a first number of pixels, each encoded frame composed of an integer multiple of n-order square matrices, the method comprising:
i) for each n-order square matrix, performing an inverse discrete cosine transformation on the n-order square matrix to produce an m-order square matrix, where m<n;
ii) for each m-order square matrix, reducing the m-order square matrix to a p×m matrix, where p<m;
iii) for each frame, producing a decoded frame composed of the integer multiple of p×m matrices derived from step ii),
wherein each decoded frame has a second number of pixels smaller than the first number of pixels.

2. The method of claim 1 wherein step i) comprises performing the matrix calculation:
Aₘ=D′ₘ(Iₘ,Oₘ)Aₙ(Iₘ,Oₘ)′Dₘ
where Aₘ is the m-order square matrix, Dₘ is an m-order discrete cosine transform matrix, Iₘ is an m-order unity matrix and Oₘ is an m-order zero matrix.

3. The method of claim 1, wherein step ii) comprises performing the matrix calculation:
Aₚₘ=TₚₘAₘ
where Aₘ is the m-order square matrix, Aₚₘ is the p×m matrix and Tₚₘ is a p×m matrix having elements selected such that rows of the Aₘ matrix are averaged in the matrix calculation to produce the Aₚₘ matrix.

4. The method of claim 1 wherein step iii) comprises producing a YCbCr frame composed of the integer multiple of p×m matrices.

5. The method of claim 1, wherein n is an integer multiple of m and m is an integer multiple of p.

6. The method of claim 5 wherein n is 8, m is 4 and p is 2.

7. The method of claim 3, wherein Tₚₘ is the matrix:
$$[ \begin{matrix}0.5 & 0.5 & 0 & 0 \\ 0 & 0 & 0.5 & 0.5\end{matrix} ] .$$

8. The method of claim 1, wherein the digital video file comprises a plurality of cif mpeg-4 frames each having a pixel resolution of 352×288 and each decoded frame is upscaled to a cif frame having a pixel resolution of 176×144.

9. A method of detecting a method of video decoding a digital video file having a plurality of encoded frames, the method comprising the steps of:
i) providing a test file having a test frame, the test frame composed of a plurality of test matrices of the form:
$$[ \begin{matrix}{D}_{4}^{′} * S * {D}_{4} & {M}_{1} \\ {M}_{2} & {M}_{3}\end{matrix} ]$$
where D₄ is a 4×4 DCT transform matrix, M₁, M₂, M₃ are any 4×4 matrices and S is the matrix:
$$[ \begin{matrix}- a & - a & - a & - a \\ a & a & a & a \\ - a & - a & - a & - a \\ a & a & a & a\end{matrix} ]$$
where a≠0;
ii) performing the method according to claim 7; and
iii) determining whether the decoded test frame is composed of zero matrices.

10. A computer program product, comprising a computer readable medium having thereon computer program code such that, when said program is loaded onto a computer, the computer executes the procedure of claim 1.

11. A hand-portable electronic device configured to perform the method according to claim 1.
